(19) United States
(12) Patent Application Publication
(10) Pub. No.: US 2014/0270618 A1
(43) Pub. Date: Sep. 18, 2014

(54) WAVELENGTH TUNABLE INTEGRATED OPTICAL SUBASSEMBLY BASED ON POLYMER TECHNOLOGY

(71) Applicant: GIGOPTIX, INC., San Jose, CA (US)

(72) Inventors: RALUCA DINU, SANTA CLARA, CA (US); GUOMIN YU, SANTA BARBARA, CA (US); CAILIN WEI, SAN JOSE, CA (US); GIOVANNI DELROSSO, CALTIGNAGA (IT); ERIC MILLER, SEATTLE, WA (US); AVISHAY KATZ, PALO ALTO, CA (US); ANDREA BETTI-BERUTTO, MENLO PARK, CA (US)

(73) Assignee: GIGOPTIX, INC., San Jose, CA (US)

(21) Appl. No.: 14/215,592

(22) Filed: Mar. 17, 2014

Related U.S. Application Data
(60) Provisional application No. 61/791,617, filed on Mar. 15, 2013.

(51) Int. Cl. H01S 3/00; H01S 3/10; G02F 1/225

(52) U.S. Cl. CPC H01S 3/0085; G02F 1/225; H01S 3/10; G02F 2001/212
USPC 385/3

(57) ABSTRACT

An optical sub assembly can include a distributed feedback (DFB) tunable laser and an optical modulator. Wavelength selection and phase adjustment portions of the DFB laser, as well as an electro-optic (EO) modulator can be formed from polymer waveguides including hyperpolarizable chromophores disposed on a single substrate.

### CROSS-REFERENCE TO RELATED APPLICATIONS

The present application claims priority benefit from U.S. Provisional Patent Application No. 61/791,617, entitled “WAVELENGTH TUNABLE INTEGRATED OPTICAL SUBASSEMBLY BASED ON POLYMER TECHNOLOGY”, filed Mar. 15, 2013; which, to the extent not inconsistent with the disclosure herein, is incorporated by reference.

### SUMMARY

According to an embodiment, a high speed, 100 gigabit-per-second (100G) monolithically integrated transmitter optical sub-assembly (TOSA) includes optical devices based on polymer technology. According to an embodiment, a tunable laser includes one or more polymer-based wavelength selectors in a distributed feedback (DFB) architecture configured to provide controlled wavelength output that can cover the entire optical communication C band of 1528 to 1565 nanometers (nm). A 100G dual polarization-quadrature phase shift keyed (DP-QPSK) electro-optic (EO) modulator can be integrated onto the same substrate as the laser DFB system. Both the DFB wavelength selector device(s) and the EO modulators can be fabricated using spin-cast and etched polymer waveguide materials.

According to an embodiment, the DFB wavelength selector device(s) and EO modulators are formed on a substrate that is diced from a single wafer. The wafer may be semiconductor (e.g., silicon or ITO-coated silicon), semiconductor-on-glass (e.g., silicon on fused silica glass), or insulator wafer (e.g., fused silica glass). In one embodiment, polymer waveguide materials are formed to include a waveguide core structure including one or more hyperpolarizable chromophores adjacent to a waveguide cladding structure that does not include the hyperpolarizable chromophore(s), wherein the waveguide core has a higher refractive index than the cladding. In another embodiment, the waveguide cladding structure includes hyperpolarizable chromophore(s) and a higher index waveguide core is made without hyperpolarizable chromophores. The hyperpolarizable chromophore(s) are poled in at least EO modulation regions to provide modulator structures configured for EO light modulation. The hyperpolarizable chromophores can be poled or can optionally remain unpoled in device structures configured for relatively low speed thermo-optic (TO) modulation (e.g., in the DFB wavelength selector structure(s)) and in non-active waveguide structures such as input waveguide(s), splitters, combiners, and output waveguide(s). If poled in non-EO structures, the hyperpolarizable chromophore is not electrically modulated, and therefor does not vary the refractive index electro-optically (although the refractive index may be modified thermally).

According to embodiments, this hyperpolarizable chromophore modulator structure provides 100G modulation speed. Embodiments may offer 1) small dimensions, 2) simple fabrication processes, 3) high yield, 4) low cost, and/or 5) high reliability comparing to conventional TOSA, ROSA, and TOSA/ROSA components.

According to an embodiment, an optical sub-assembly includes a tunable laser. The tunable laser includes an optical gain chip configured to output one or more of a plurality of modes of optical energy. The tunable laser includes a TO tunable polymer device configured to tune wavelengths of the modes of optical energy and configured to select one of the plurality of modes for lasing and output as coherent light on a tunable laser output waveguide. An EO modulator is operatively coupled to receive the coherent light from the tunable laser. The EO modulator to receive data as modulation voltages on modulation electrodes disposed adjacent to an EO polymer waveguide structure. The received modulation voltages selectively hyperpolarize and depolarize aligned chromophores to modulate the coherent light. The modulated light corresponding to the received data is output, typically into a polymer combiner structure. The combiner structure (in combination with the splitter structure) is structured to maintain beam coherence of the light. When combining arms of devices, the modulated coherent beam constructively or destructively interferes, depending on relative phases of the arms caused by the EO index shifts. Often, pairs of Mach-Zehnder arms are arranged in a push-pull relationship. Further combiner structure combines sine and cosine components (each typically carrying a phase shift keyed signal caused by the interference of respective Mach-Zehnder modulators) to form the quadrature modulation. Typically, one quadrature channel is propagated directly to an output waveguide and a second quadrature channel is polarization rotated 90° before being combined with the first quadrature channel, to form superimposed quadrature modulated signals carried at respective linearly independent polarization angles. The TO tunable device, the EO modulator, the input waveguide, the splitter, the combiner, and the output waveguide can be formed on a common substrate as polymer waveguide devices.

According to an embodiment, a DFB laser modulator includes an optical gain chip, a TO polymer phase tuner, and a TO polymer Bragg grating continuous with the polymer phase tuner. The continuous devices are formed on a single wafer. The devices can be independently adjusted thermo-optically with separate heaters. The polymer phase tuner and polymer Bragg grating are aligned to receive radiation from the optical gain chip. The DFB laser modulator can be embodied as a Mach-Zehnder polymer modulator continuous with the polymer Bragg grating and the polymer phase tuner. Typically, several channels of Mach-Zehnder modulator devices are included on each die. The Mach-Zehnder polymer modulator(s) receives a modulation signal separate from the TO polymer phase tuner and TO polymer Bragg grating.

According to an embodiment, a DFB laser modulator includes an optical gain chip and, aligned to receive radiation from the optical gain chip, a polymer phase tuner and polymer wavelength selector formed in an optical polymer stack on the same substrate. The polymer phase tuner can include an external cavity optical length adjustor. The polymer wavelength selector can include a Bragg grating such as a sampled Bragg grating. The polymer phase tuner and polymer wavelength selector can be TO tunable devices including a relatively high index region formed from a host polymer and hyperpolarizable chromophore(s). A silicon optical amplifier (SOA) can receive a selected wavelength from the TO tunable devices, such as by vertical launch of the selected wavelength of light. The SOA can vertically launch the amplified wavelength back to the optical polymer stack. A plurality of beam splitters such as Y-junctions or evanescent couplings formed in the optical polymer stack can split the amplified wavelength into a plurality of waveguides. The plurality of waveguides can couple the light to a corresponding plurality of EO modulators formed in the optical polymer stack, and disposed on the same substrate as the TO tunable devices and the beam splitters. The EO modulators can modulate phase of the received wavelength of light. The modulated light is combined to form QPSK modulated light for transmission of data. A polarization rotator can rotate a portion of the phase modulated or QPSK modulated light, and a combiner can combine the rotated portion of the modulated light with a non polarization-rotated portion of the light to form a DP-QPSK multiplexed modulated light signal for data transmission. Beam combiners can be formed in the optical polymer stack on the same substrate as the TO-tunable devices, the beam splitters, and the EO modulators.

According to an embodiment, a DFB laser with integrated modulator includes an optical gain chip. A polymer phase tuner and wavelength selector including a polymer ring-resonator may be aligned to receive radiation from the optical gain chip. A SOA may be aligned to receive radiation from the DFB gain chip. The polymer phase tuner and wavelength selector is be formed on a substrate separate from the SOA.

According to an embodiment, a receiver optical sub assembly (ROSA) includes an integrated wavelength tunable DFB laser and EO modulator as a wavelength tunable optical clock signal source. The DFB laser includes an optical gain chip, polymer phase tuner, and a polymer Bragg grating continuous with the polymer phase tuner. The polymer phase tuner and a polymer Bragg grating are be aligned to receive radiation from the optical gain chip. The optical clock signal source includes a Mach-Zehnder EO polymer modulator continuous with the polymer Bragg grating and the polymer phase tuner.

According to an embodiment, an integrated transmitter—receiver optical sub assembly (TOSA/ROSA). The TOSA portion includes a DFB laser modulator including an optical gain chip, polymer phase tuner, and a polymer Bragg grating continuous with the polymer phase tuner. The polymer phase tuner and a polymer Bragg grating continuous with the polymer phase tuner are TO devices aligned to receive radiation from the optical gain chip. The TOSA portion includes a Mach-Zehnder EO polymer modulator continuous with the polymer Bragg grating and the polymer phase tuner. The ROSA portion includes an integrated wavelength tunable DFB laser and EO modulator as a wavelength tunable optical clock signal source. The DFB laser may include an optical gain chip, polymer phase tuner, and a polymer Bragg grating continuous with the polymer phase tuner. The polymer phase tuner and a polymer Bragg grating are TO devices aligned to receive radiation from the optical gain chip. The optical clock signal source includes a Mach-Zehnder EO polymer modulator continuous with the polymer Bragg grating and the polymer phase tuner.

According to an embodiment, an integrated transmitter-receiver optical subassembly (TOSA/ROSA) may include a single DFB laser including an optical gain chip, a TO polymer phase tuner, and a TO polymer Bragg grating continuous with the polymer phase tuner. A splitter (that may be continuous with the polymer phase tuner and polymer Bragg grating) splits the wavelength tuned light signal into light for generating a data transmission signal for the TOSA portion and light for generating a clock signal for the ROSA portion. Polymer EO modulation channels for the data signal and for the clock signal are disposed on a single substrate. The polymer EO modulation channels are continuous with the polymer phase tuner and polymer Bragg grating.

### BRIEF DESCRIPTION OF THE DRAWINGS

FIG. 1 is a block diagram of a transmitter optical subassembly (TOSA), according to an embodiment.

FIG. 2 are chemical structures of hyperpolarizable chromophores used in polymer waveguide devices of the TOSA of FIG. 1, according to embodiments.

FIG. 3 is a cross-section of an illustrative trench polymer waveguide used in the TOSA of FIG. 1 and including a hyperpolarizable chromophore of FIG. 2, according to an embodiment.

FIG. 4 is a cross-section of an illustrative rib polymer waveguide used in the TOSA of FIG. 1 and including a hyperpolarizable chromophore of FIG. 2, according to another embodiment.

FIG. 5A is a diagram of a distributed feedback (DFB) wavelength tunable laser including a TO tunable device with tuning electrodes, according to an embodiment.

FIG. 5B is a diagram of a DFB wavelength tunable laser including a TO tunable device with tuning electrodes, according to another embodiment.

FIG. 6A is a diagram of a wavelength selector including a uniform Bragg grating, according to an embodiment.

FIG. 6B is a diagram of a wavelength selector including a sampled Bragg grating, according to an embodiment.

FIG. 7 is a diagram of a DFB laser modulator including a polymer ring resonator phase tuner, according to an embodiment.

FIG. 8 is a plot of an experimental result showing a polymer Bragg grating filtering effect referenced to a polymer waveguide without a Bragg grating, according to an embodiment.

FIG. 9 is a plot of an experimental result showing a lasing spectrum of a DFB laser that included an optical gain chip and polymer waveguide Bragg grating, according to an embodiment.

FIG. 10 is a plot of an experimental result showing tuning results of the laser illustrated by FIG. 9, according to an embodiment.

FIG. 11 is a depiction of an integrated TOSA, according to another embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

FIG. 1 is a block diagram of a transmitter optical sub-assembly 100 (TOSA), according to an embodiment. The optical sub-assembly 100 includes a tunable laser 102 including an optical gain chip 104 configured to output one or more of a plurality of modes of optical energy. The tunable laser 102 includes a thermo-optic (TO) tunable device 106 configured to tune wavelengths of the modes of optical energy, and to select one of the plurality of modes for lasing and output as coherent light on a tunable laser output waveguide. An electro-optic (EO) modulator 114 is operatively coupled to receive the coherent light from the tunable laser 102, to receive data, and to modulate the coherent light to output modulated light corresponding to the received data. The TO tunable device 106 and the EO modulator 114 may be formed on a common substrate 118 as polymer waveguide devices.

The tunable laser is formed as a distributed feedback (DFB) semiconductor laser. The optical gain chip 104 can include an indium phosphide semiconductor device, for example. The TO tunable device 106 and the EO modulator 114 are formed as polymer waveguide devices. The EO modulator includes a hyperpolarizable chromophore. The TO tunable device(s) 106 can optionally also include the hyperpolarizable chromophore that is not electrically modulated.

FIG. 2 shows illustrative chemical structures of hyperpolarizable chromophores that are used in the EO polymer optical devices described herein, according to embodiments.

Referring to FIG. 2:

X is silicon or carbon;

R¹ is, independently at each occurrence, H, an alkyl group, a hetero alkyl group, an alkoxy group, an aryl group, or a hetero aryl group; and

R² is, independently at each occurrence, an alkyl group, a halogenated alkyl group, an aryl group, a substituted aryl group, or a halogenated aryl group.

Illustrative poled hyperpolarizable chromophores disposed in polymer waveguides are disclosed in U.S. patent application Ser. No. 12/963,479, entitled “INTEGRATED CIRCUIT WITH OPTICAL DATA COMMUNICATION,” filed Dec. 8, 2010, which, to the extent not inconsistent with this disclosure, is incorporated by reference herein.

One embodiment is a second order nonlinear optical chromophore having the structure D-π-A, wherein D is a donor, π is a π-bridge, and A is an acceptor, and wherein at least one of D, π, or A is covalently attached to a substituent group including a substituent center that is directly bonded to at least two aryl groups, preferably three aryl groups. What is meant by terms such as donor, π-bridge, and acceptor; and general synthetic methods for forming D-π-A chromophores are known in the art, see for example U.S. Pat. No. 6,716,995, incorporated by reference herein.

A donor (represented in chemical structures by “D” or “Dⁿ” where n is an integer) includes an atom or group of atoms that has a low oxidation potential, wherein the atom or group of atoms can donate electrons to an acceptor “A” through a π-bridge. The donor (D) has a lower electron affinity that does the acceptor (A), so that, at least in the absence of an external electric field, the chromophore is generally polarized, with relatively less electron density on the donor (D). Typically, a donor group contains at least one heteroatom that has a lone pair of electrons capable of being in conjugation with the p-orbitals of an atom directly attached to the heteroatom such that a resonance structure can be drawn that moves the lone pair of electrons into a bond with the p-orbital of the atom directly attached to the heteroatom to formally increase the multiplicity of the bond between the heteroatom and the atom directly attached to the heteroatom (i.e., a single bond is formally converted to double bond, or a double bond is formally converted to a triple bond) so that the heteroatom gains formal positive charge. The p-orbitals of the atom directly attached to the heteroatom can be vacant or can be part of a multiple bond to another atom other than the heteroatom. The heteroatom can be a substituent of an atom that has pi bonds or can be in a heterocyclic ring. Exemplary donor groups include but are not limited to R₂N— and, RₙX¹⁻, where R is alkyl, aryl or heteroaryl, X¹ is O, S, P, Se, or Te, and n is 1 or 2. The total number of heteroatoms and carbons in a donor group can be about 30, and the donor group can be substituted further with alkyl, aryl, or heteroaryl. The “donor” and “acceptor” terminology is well known and understood in the art. See, e.g., U.S. Pat. Nos. 5,670,091, 5,679,763, and 6,090,332.

An acceptor (represented in chemical structures by “A” or “Aⁿ” where n is an integer) is an atom or group of atoms that has a low reduction potential, wherein the atom or group of atoms can accept electrons from a donor through a π-bridge. The acceptor (A) has a higher electron affinity that does the donor (D), so that, at least in the absence of an external electric field, the chromophore is generally polarized, with relatively more electron density on the acceptor (D). Typically, an acceptor group contains at least one electronegative heteroatom that is part of a pi bond (a double or triple bond) such that a resonance structure can be drawn that moves the electron pair of the pi bond to the heteroatom and concomitantly decreases the multiplicity of the pi bond (i.e., a double bond is formally converted to single bond or a triple bond is formally converted to a double bond) so that the heteroatom gains formal negative charge. The heteroatom can be part of a heterocyclic ring. Exemplary acceptor groups include but are not limited to —NO₂, —CN, —CHO, COR, CO₂R, —PO(OR)₃, —SOR, SO₂R, and —SO₃R where R is alkyl, aryl, or heteroaryl. The total number of heteroatoms and carbons in an acceptor group is about 30, and the acceptor group can be substituted further with alkyl, aryl, and/or heteroaryl. The “donor” and “acceptor” terminology is well known and understood in the art. See, e.g., U.S. Pat. Nos. 5,670,091, 5,679,763, and 6,090,332.

A “π-bridge” or “electronically conjugated bridge” (represented in chemical structures by “π” or “πⁿ” where n is an integer) includes an atom or group of atoms through which electrons can be delocalized from an electron donor (defined above) to an electron acceptor (defined above) through the orbitals of atoms in the bridge. Such groups are very well known in the art. Typically, the orbitals will be p-orbitals on double (sp²) or triple (sp) bonded carbon atoms such as those found in alkenes, alkynes, neutral or charged aromatic rings, and neutral or charged heteroaromatic ring systems. Additionally, the orbitals can be p-orbitals on atoms such as boron or nitrogen. Additionally, the orbitals can be p, d or f organometallic orbitals or hybrid organometallic orbitals. The atoms of the bridge that contain the orbitals through which the electrons are delocalized are referred to here as the “critical atoms.” The number of critical atoms in a bridge can be a number from 1 to about 30. The critical atoms can be substituted with an organic or inorganic group. The substituent can be selected with a view to improving the solubility of the chromophore in a polymer matrix, to enhancing the stability of the chromophore, or for other purpose.

The substituent group (or any of multiple substituent groups) can be covalently attached to one or more of D, π, and A through a variety of linkages including single bonds, single atoms, heteroatoms, metal atoms (e.g., organometallics), aliphatic chains, aryl rings, functional groups, or combinations thereof. The substituent center can have multiple atoms (e.g., an aryl or aliphatic ring), can be a single atom (e.g., a carbon, silicon, or metal atom), or can be a combination thereof (e.g., a ring system where one aryl group is bonded to one atom of the ring system and the other two aryl groups are bonded to another atom in the ring system).

For example, in some embodiments the substituent center includes a carbon atom, a heteroatom, or a metal atom. In other embodiments, the substituent center can be a carbon atom, a silicon atom, a tin atom, a sulfur atom, a nitrogen atom, or a phosphorous atom. In an embodiment, the substituent center can be a 3-, 4-, 5-, or 6-membered ring like a benzene ring, thiophene ring, furan ring, pyridine ring, imidazole ring, pyrrole ring, thiazole ring, oxazole ring, pyrazole ring, isothiazole ring, isooxazole ring, or triazole ring.

The aryl groups bonded to the substituent center can be further substituted with alkyl groups, heteroatoms, aryl groups, or a combination thereof. For example, in some embodiments, the aryl groups can, independently at each position, include a phenyl ring, a naphthyl ring, a biphenyl group, a pyridyl ring, a bipyridyl group, thiophene group, furan group, imidazole group, pyrrole group, thiazole group, oxazole group, pyrazole group, isothiazole group, isooxazole group, triazole group or an anthracenyl group.

In an embodiment, the substituent group includes the structure:

[chemical structure]

wherein: X is the substituent center; Ar¹, Ar², and Ar³ are the aryl groups; and L is a covalent linker attached to D, π, or A. According to various embodiments, X can be C, Si, N, B, Sn, S, S(O), SO₂, P(O) (phosphine oxide), P (phosphine), or an aromatic ring of any kind. In some embodiments, Ar¹, Ar², and Ar^{a} each independently include a substituted or un-substituted phenyl ring, a substituted or un-substituted benzyl ring, a substituted or un-substituted naphthyl ring, a substituted or un-substituted biphenyl group, a substituted or un-substituted pyridyl ring, a substituted or un-substituted bipyridyl group, a substituted or un-substituted thiophene ring, a substituted or un-substituted benzothiophenene ring, a substituted or un-substituted imidazole ring, a substituted or un-substituted thiozale ring, substituted or un-substituted thienothiophene group, substituted or un-substituted a substituted or un-substituted quinoline group, or a substituted or un-substituted anthracenyl group. In some embodiments, L includes the structure:

[chemical structure]

wherein: R¹ is independently at each occurrence an H, an alkyl group, or a halogen; Y¹ is —C(R¹)₂—, O, S, —N(R¹)—, —N(R¹)C(O)—, —C(O)₂—, —C₆H₆—, or —OC₆H₆—, thiophenyl,; n is 0-6; and m is 1-3.

Electro-optic polymers including these nonlinear optical chromophores can show high electro-optic coefficient. The temporal stability is significantly increased compared to electro-optic polymers including chromophores where alkyl groups are substituted for the aryl groups, where the aryl groups have π(pi)-π(pi) interactions (also referred to herein as pi interactions) between aryl bulky groups on the chromophore and aryl groups on polymer. In this context, the symbol “π” can be used generally to refer to a system of one or more multiple bonds, linear or cyclic, as is known on the art instead of in the context of representing the conjugated π-bridge of a chromophore. The aryl groups can be sterically larger than the alkyl groups. The pi-interactions between the aryl bulky group/s on the chromophore and the aryl groups on the polymer can be enhanced by complementary geometric dispositions of the aryl groups that enhance the pi interactions (e.g., aryl groups tetrahedrally disposed around a substituent center in the chromophore bulky group can favorably pi-interact (e.g., stack) more efficiently with aryl groups tetrahedrally disposed around a carbon in the polymer backbone).

Donors, acceptors, and π-bridge moieties can include functional groups that are covalently bonded to the L group.

According to embodiments, D includes:

[chemical structure]

π includes:

[chemical structure]

[chemical structure]

and A includes:

[chemical structure]

wherein: R¹, independently at each occurrence is H, an aliphatic group such as an alkyl or alkoxy group, or an aryl group. R², independently at each occurrence, is an alkyl group, a halogenated alkyl group, a halogenated aryl group, or an aryl group with or without substitutions; Z is a single bond,
—CH═CH—, —N═N—, or —N═CH—; Y², independently at each occurrence, is CH₂, O, S, N(R¹), Si(R¹), S(O), SO₂, —CH(R¹)— or —C(R¹)₂—; R³ independently at each occurrence is a cyano group, a nitro group, an ester group, or a halogen; and at least one R¹, R², or R³ includes the substituent group. m is 1-6 and n is 1-4.

In another embodiment, D has one of the structures:

[chemical structure]

wherein X is a substituent center; Ar¹, Ar², Ar³, Ar⁴, Ar⁵, and Ar⁶ are aryl groups; Ar⁷ is a conjugated aromatic group; R¹ of D independently at each occurrence is H, an alkyl group, a heteroalkyl group, an aryl group, or a hetero aryl group; p is 2-6; l is 0-2; m is 1-3; and n is 1-3; π has the structure:

[chemical structure]

and wherein R¹ of π independently includes

[chemical structure]

or is H, an alkyl group, a heteroalkyl group, an aryl group, or a hetero aryl group; L is a covalent linker; z is 1,2-vinylene, 1,4-phenylene, or 2,5-thiophenylene, Y² is S, O or SiR²₂, where R² is aliphatic group, and m is 1-3. In some embodiments, X is C or Si
In another embodiment, π includes:

[chemical structure]

### and A is:

[chemical structure]

wherein: R¹ is independently at each occurrence an H, an alkyl group, or a halogen; Z is a single bond or —CH═CH—; Y² is O, S, —C(R¹)₂—; R² is independently at each occurrence an alkyl group or an aryl group; and m=1-3. In embodiments, the nonlinear optical chromophore includes one of the structures shown in FIG. 1 wherein X, R¹, and R² are as described above.

In another embodiment, A has the structure:

[chemical structure]

wherein: R², independently at each occurrence is H, an aliphatic group such as a branched or un-branched alkyl or alkoxy group, or a substituted or un-substituted aryl group. R³, independently at each occurrence, is cyano, CF₃, nitro group, an ester group, a halogen, or an substituted or un-substituted aryl group; Y², is CH₂, O, S, N(R²), Si(R²)₂ or —C(R²)₂—. In another embodiment, at least one R¹ of π includes

[chemical structure]

According to an embodiment, a nonlinear optical chromophore has the structure D-π-A, wherein D is a donor, π is a π-bridge, and A is an acceptor; and wherein at least one of D, π, or A is covalently attached to a substituent group including at least one of:

[chemical structure]

and wherein: X is C or Si; Y¹ is —C(R¹)₂—, O, S, —N(R¹)—, —N(R¹)C(O)—, —C(O)₂—; Y³ is N or P; and Ar¹, Ar², and Ar³ are aryl groups. The aryl groups, D, π, and A can be as described above for example.

Other embodiments include electro-optic composites and polymers including one or more of the nonlinear optical chromophores described above. Typically, the polymer is poled with an electric field to induce electro-optic activity. Other techniques such as self-organization or photo-induced poling can also be used. The nonlinear optical chromophore can be covalently attached to the polymer matrix (e.g., as in a side-chain polymer or a crosslinked polymer) or can be present as a guest in a polymer matrix host (e.g., a composite material). The nonlinear chromophore can also be present as guest in the polymer matrix and then be covalently bonded or crosslinked to the matrix before, during, or after poling. Polymers that can be used as a matrix include, for example, polycarbonates, poly(arylene ether)s, polysulfones, polyimides, polyesters, polyacrylates, and copolymers thereof.

In some embodiments, bulky groups on the chromophore can be used to change the Tg and to reduce the optical loss of electro-optic (EO) polymers by changing the physical interaction between polymer host and chromophore guest. We found that the physical interaction between host polymer and guest molecular can be increased by selecting specific chemical structure of the isolating (e.g., bulky) group on the chromophore. Physical interactions can include, for example, pi-pi interactions, size interactions that block chromophore movement significantly below Tg (e.g., there is not enough free volume in the polymer composite at Tg for translation of the bulky group, and hence the chromophore, which is generally required for chromophore relaxation), and preorganized binding interactions where the bulky groups fit preferentially into conformationally defined spaces in the polymer, or any combination thereof. In some embodiment, the physical interactions are controlled or supplemented by van der Waals forces (e.g., Keesom, Debye, or London forces) among the moiety of the bulky groups and aryl groups on polymer chains. Such non-covalent interactions can increase temporal stability below Tg and decrease optical loss while improving chromophore loading density and avoiding the deleterious effects of crosslinking on the degree of poling-induced alignment.

Pi-pi interactions are known in the art and can include interaction, for example, between a pi-system and another pi-system (e.g., an aromatic, a heteroaromatic, an alkene, an alkyne, or carbonyl function), a partially charged atoms or groups of atoms (e.g., —H in a polar bond, —F), or a fully charged atom or groups of atoms (e.g., —NR(H)₃⁺, —BR(H)₃⁻). Pi-pi interaction(s) can increase affinity of the chromophore guest for the polymer host and increase energy barriers to chromophore movement, which is generally required for chromophore relaxation and depoling. In some embodiments, pi-interactions can be used to raise the Tg of a polymer (e.g., by increasing interactions between polymer chains) or the Tg of a polymer composite (e.g., by increasing interactions between the polymer host and the chromophore guest). In some embodiments, the pi-interactions of the bulky groups increase the Tg of the polymer composite compared to when pi-interacting moieties on the bulky groups are replaced with moieties that have no or weak pi-interactions. In some embodiments, pi-interacting groups on the chromophore are chosen to interact preferentially with pi-interacting groups on the polymer chain. Such preferential interactions can include, for example, pi-interacting donors/acceptors on the bulky group with complementary pi-interacting acceptors/donors of the polymer chain, or spatial face-to-face and/or edge-to-face interactions between pi-interacting groups on the chromophores and polymer chains, or any combination thereof. In some embodiments, multiple interactions such as a face-to-face and face-to-edge between one or multiple moieties on the chromophore bulky group with multiple or one moieties on the polymer chain can increase interaction strength and temporal stability. The pi-interactions between the aryl bulky group/s on the chromophore and the aryl groups on the polymer can be enhanced by complementary geometric dispositions of the aryl groups that enhance the pi interactions (e.g., aryl groups tetrahedrally disposed around a substituent center in the chromophore bulky group can favorably pi-interact (e.g., stack) more efficiently with aryl groups tetrahedrally disposed around a carbon in the polymer backbone.

In other embodiments, the polymer can be chosen because the chain adopts certain conformations and spatial distributions (e.g., preorganization) of pi-interacting groups that favor face-to-face or face-to-edge interactions with the pi-interacting groups on the chromophore. Some embodiments can have multiple face-to-face interactions between pi-interacting groups on the polymer and the chromophore or a combination of face-to-face and face-to-edge pi-interactions. In other embodiments, pi-interacting donors generally have electron rich p-systems or orbitals and pi-interacting acceptors generally have electron poor p-systems or orbitals. In some embodiments, the bulky groups on the chromophore have pi-interacting donors or pi-interacting acceptors that are complimentary to pi-interacting acceptors or pi-interacting donors on the polymer chain. In some embodiments, such pi-interacting acceptors can include, for example, heterocycles such as pyridines, pyrazines, oxadiazoles, etc, and pi-interacting donors can include, for example, heterocycles such as thiophene, furan, carbazole, etc. The pi-interacting donors/acceptors can also include aryl groups that are electron rich/poor from electron donating/withdrawing substituents. In some embodiments, the bulky group includes at least one pi-interacting acceptor complementary to a pi-interacting donor on the polymer chain. In some embodiments, the bulky group includes at least one pi-interacting donor complementary to a pi-interacting acceptor on the polymer chain.

In some embodiments, the size of the bulky groups prevents translation/depoling of the chromophore in the polymer free volume significantly (e.g., 20° C.) below the Tg of the composite. In some embodiments, the bulky group is substantially 3-dimensional (e.g., the bulky group has bulk-forming moieties tetrahedrally or trigonal bipyramidally disposed around a substituent center atom rather than having a substantially planar or linear arrangement of the bulk-forming moieties around the substituent center atom). Such 3-dimensionality can reduce the possibility of the bulky group, and hence the chromophore, form translating through free volume compared to a planar or linear bulky group. The bulk-forming groups can independently include, for example, and an organic moiety having 5 or more carbon atoms. In some embodiments, the bulk-forming groups can independently include conformationally rigidified structures such as rings. The rings can be aliphatic, aromatic, or any combination thereof. In some embodiments, the bulk-forming groups can independently include aryl groups (aromatics, polycyclic aromatics, substituted aromatics, heteroaromatics, polycyclic heteroaromatics, and substituted heteroaromatics.

In other embodiments, the bulky groups fit preferentially into conformationally/spatially defined areas (e.g., pockets) of the polymer. Such areas can be referred to as preorganized for interaction with the bulky groups. Such preorganization can result from the polymer backbone adopting a predetermined conformation or from groups (e.g., pendant groups) of the polymer adopting predetermined conformation. In some embodiments, the preorganized area of the polymer can have pi-interacting groups, pi-interacting atoms, shape-interacting groups, H-bonding groups, etc. that are spatially disposed to preferentially interact with complementary moieties on the bulky group. The interactions of the preorganized area on the polymer and the bulky group can include an interaction described above or any multiple combinations thereof. In some embodiments, preorganization provides additional stability compared to just the stabilizing interaction alone. For example, one part of the preorganized pocket can pi-interact with a pi-interacting moiety on the bulky group and another part of the preorganized pocket can interact with the same or different moiety of the bulky group with van der Waals forces.

In other embodiments, the chromophore can include more than one bulky group. In some embodiments, the chromophore has at least one bulky group on the donor and at least one bulky group on the p-bridge or acceptor. More than one bulky group on different parts of the chromophore can increase interactions with the polymer backbone and make translation and depoling more difficult.

One embodiment includes a poled nonlinear optical chromophore and a host polymer, wherein the nonlinear optical chromophore is substituted with two or more bulky groups and the host polymer is configured to cooperate with the bulky groups to impede chromophore depoling. In some embodiments, the nonlinear optical chromophore has the structure D-π-A; D is substituted with a bulky group; and π is substituted with a bulky group. In another embodiment, the bulky groups and the polymer cooperate via pi-interactions. In another embodiment, the bulky groups include aryl groups. In some embodiments, the aryl groups independently can be an aryl hydrocarbon, an aryl polycyclic hydrocarbon, a heteroaryl, or a polycyclic heteroaryl. In some embodiments, the host polymer can be a polycarbonate, a poly(arylene ether), a polysulfone, a polyimide, a polyester, a polyacrylate, or any copolymer thereof. In some embodiments, the host polymer has a Tg greater than 150° C. and can be a polysulfone; a polyester; a polycarbonate; a polyimide; a polyimideester; a polyarylether; a poly(methacrylic acid ester); a poly(ether ketone); a polybenzothiazole; a polybenzoxazole; a polybenzobisthiazole; a polybenzobisoxazole; a poly(aryl oxide); a polyetherimide; a polyfluorene; a polyarylenevinylene; a polyquinoline, a polyvinylcarbazole; or any copolymer thereof.

Another embodiment is an electro-optic device including a polymer described herein, wherein the Vπ of the device is operational after 2000 hours at 85° C. In some embodiments, the electro-optic device has a V. that does not increase more than 5% after 2000 hours at 85° C. In some embodiments, the electro-optic device has a V. that does not increase more than 10% after 2000 hours at 85° C. In some embodiments, the electro-optic device has a V. that does not increase more than 15% after 2000 hours at 85° C. In some embodiments, the electro-optic device has a V. that does not increase more than 20% after 2000 hours at 85° C.

In some embodiments, an electro-optic polymer includes a nonlinear optical chromophore and a host polymer, wherein: the nonlinear optical chromophore has a bulky substituent comprising at least one aryl group and the host polymer has an aryl group selected to interact with the aryl group of the substituent. In some embodiments, wherein the substituent includes 2 or 3 aryl groups. In some embodiments, the chromophore has the structure D-π-A and the triaryl group has the structure

[chemical structure]

wherein: D is a donor; π is a π-bridge; A is an acceptor; X is a substituent center; Ar¹, Ar², and Ar³ are the aryl groups; and L is a covalent linker attached to D, or A.

In another embodiment, an electro-optic polymer includes a nonlinear optical chromophore having the structure D-π-A, wherein D is a donor, π is a π-bridge, A is an acceptor, and at least one of D, π, or A is covalently attached to a bulky group comprising at least one aryl group, and wherein the electro-optic polymer has greater temporal stability than when an alkyl group is substituted for the aryl group. In some embodiments, the bulky group includes at least two aryl groups, and the electro-optic polymer has greater temporal stability than when alkyl groups are substituted for the aryl groups. In another embodiment, the bulky group includes at least three aryl groups, and the electro-optic polymer has greater temporal stability than when alkyl groups are substituted for the aryl groups.

In another embodiment, an electro-optic polymer includes a nonlinear optical chromophore and a host polymer, wherein the nonlinear optical chromophore has a substituent group comprising at least two aryl groups, the host polymer includes a subunit comprising at least two aryl groups, and the aryl groups of the nonlinear optical chromophore align preferentially with the aryl groups of the subunit. In some embodiments, the host polymer is a polysulfone; a polyester; a polycarbonate; a polyimide; a polyimideester; a polyarylether; a poly(methacrylic acid ester); a poly(ether ketone); a polybenzothiazole; a polybenzoxazole; a polybenzobisthiazole; a polybenzobisoxazole; a poly(aryl oxide); a polyetherimide; a polyfluorene; a polyarylenevinylene; a polyquinoline, a polyvinylcarbazole; or any copolymer thereof.

Compatibility and stability of composites comprising chromophores having bulky groups with various host polymers were studied, including the EO properties. Low optical loss is achieved due to good compatibility, which also is proven by a clean, single Tg transition. EO coefficients with various host polymers are characterized and their temporal stability is monitored at different temperatures. Meanwhile, modulators were fabricated out of those EO composites and their stability is further confirmed.

Some embodiments have a chromophore structure that includes bulky groups. Such chromophores show good compatibility with host polymers and lead to high glass transition temperature. Guest-host systems were studied using these chromophores with various host polymers with different glass transition temperature. Host polymers can belong to polycarbonate family with low to high Tg. In some embodiments, high Tg of the host polymers will lead to higher Tg of the EO composites with the same chromophore.

According to embodiments, EO composites having high Tg (>120° C.) can be fabricated by using a host polymer with a glass transition temperature>120° C. In other embodiments, EO composites having high Tg (>120° C.) can be fabricated by using a host polymer with a glass transition temperature>120° C. and a chromophore with a melting point or Tg>120° C.

In another embodiment, an electro-optic composite includes greater than 35% loading by weight of a chromophore in a host polymer, wherein the Tg of the composite is higher than the melting point, or Tg, of the chromophore itself. In some embodiments, the chromophore loading by weight is at least 45% and the Tg of the composite is greater than 150° C. In another embodiment, the host polymer can be a semi-crystalline polymer with a low Tg that, when mixed with a chromophore, forms an amorphous composite with high Tg. In some embodiments, noncovalent interactions between bulky groups on the chromophore and moieties of the semi-crystalline host polymer increase the Tg of the amorphous composite.

According to embodiments, other host polymers with Tg higher than 150° C. can be used in combination with chromophores having bulky groups to produce composite EO materials having high Tg, and therefore high temperature stability over short and/or long terms. Illustrative high Tg host polymers can be formed from the following polymeric systems and/or their combinations: polysulfones; polyesters; polycarbonates; polyimides; polyimideesters; polyarylethers; poly(methacrylic acid esters); poly(ether ketones); polybenzothiazoles; polybenzoxazoles; polybenzobisthiazoles; polybenzobisoxazoles; poly(aryl oxide)s; polyetherimides; polyfluorenes; polyarylenevinylenes; polyquinolines, polyvinylcarbazole; and their copolymers.

According to an embodiment, an electro-optic polymer includes a nonlinear optical chromophore having the structure D-π-A, wherein D is a donor, π is a π-bridge, A is an acceptor, and at least one of D, π, or A is covalently attached to a substituent group including a substituent center X that is directly bonded to an aryl group, and wherein the electro-optic polymer has greater temporal stability than when an alkyl group is substituted for the aryl group. The electro-optic polymer can be a side-chain, crosslinked, dendrimeric, or composite material. According to an embodiment, the substituent center X is bonded to at least three aryl groups, and the electro-optic polymer has greater temporal stability than when alkyl groups independently are substituted for the aryl groups. According to an embodiment, the electro-optic composite has greater than 80% temporal stability at 85° C. after 100 hours.

Other embodiments include various methods for making electro-optic composites, and devices therefrom, where the electro-optic composite includes a chromophore as described above. According to an embodiment, a method includes: a) providing a polymer including a nonlinear optical chromophore having the structure D-π-A, wherein D is a donor, π is a π-bridge, A is an acceptor, and at least one of D, π, or A is covalently attached to a substituent group including a substituent center that is directly bonded to an aryl group; and b) poling the polymer to form and electro-optic polymer, wherein the electro-optic polymer has greater temporal stability than when an alkyl group is substituted for the aryl group.

Typically, an aryl group is sterically larger than an alkyl group. Typically, the polymer can be provided as a film by, for example, spin deposition, dip coating, or screen printing. The thin film can also be modified into device structures by, for example, dry etching, laser ablation, and photochemical bleaching. Alternatively, the polymer can be provided by, for example, molding or hot embossing a polymer melt. The poling may include, for example, contact or corona poling. In another method embodiment, the substituent center is bonded to or substituted with at least three aryl groups, and the electro-optic polymer has greater temporal stability than when alkyl groups independently are substituted for the aryl groups.

In some embodiments, the polymer is a composite. In some method embodiments, the aryl group is sterically larger than the alkyl group. In another method embodiment, the polymer has a T_{g}; the T_{g} of the polymer is within approximately 5° C. compared to when an alkyl group is substituted for the aryl group, and the temporal stability of the polymer is greater compared to when an alkyl group is substituted for the aryl group.

Another embodiment is an electro-optic polymer including a nonlinear optical chromophore comprising the donor:

[chemical structure]

wherein R¹ independently includes an alkyl, heteroalkyl, aryl, or heteroaryl group; R² independently at each occurrence includes an H, alkyl group, heteroalkyl group, aryl group, or heteroaryl group; R³ independently at each occurrence includes a halogen, an alkyl group, a heteroalkyl group, an aryl group, or a heteroaryl group; and n is 0-3. Chromophores made according to this embodiment have good nonlinearity due to the strong donating group and can be derivatized with a number of functional groups at the —R¹ position. In one embodiment, —R¹ includes a bulky group that interacts with the polymer host such that the π-bridge includes a bulky group that interacts with the polymer host.

EO modulators generally include hyperpolarizable chromophores that are vertically poled. The TO tunable device 106 can include hyperpolarizable chromophores that are vertically poled or can include non-poled hyperpolarizable chromophores.

FIG. 3 is a cross-section of an illustrative polymer waveguide structure 300 used in the TOSA of FIG. 1 including trench polymer waveguide 302 and including a hyperpolarizable chromophore of FIG. 2, according to an embodiment. The TO tunable device 106 and the EO modulator 114 (FIG. 1) can be formed as polymer waveguide devices including the trench waveguide structure 300.

A semiconducting or insulating substrate 304 may support at least one conductor layer patterned over the substrate 304 and configured to act as a ground electrode or TO heater 306. A planarization layer (not shown) may optionally be disposed at least partly coplanar with and over the ground electrode or TO heater 306. An optical polymer stack 308 (also referred to herein as “thin film polymer”, as in TFPS) can be disposed over the substrate 304 and ground electrode or TO heater 306. According to an alternative embodiment, the planarization layer (not shown) may be omitted, and the planarization function may be provided by a portion of the optical polymer stack 308.

In a TO tunable device 106, the structure 306 formed with the patterned conductor layer can include a resistor configured for Joule heating responsive to current dissipation from an applied voltage. The Joule heating causes a sensible temperature rise in the structure 300 to change the refractive index and the propagation speed of light passing therethrough. Such “TO modulation” can be characterized by a relatively large time constant that makes a selected refractive index relatively stable. In a TO tunable device, a top electrode 310 over the optical polymer stack 308 can be omitted.

In an EO modulator 114, a top conductor layer can be disposed over the optical polymer stack 308 and patterned to form a high speed electrode 310. The high speed electrode 310 can be configured to cooperate with the ground electrode 306 to apply a pulsed electrical field through the trench polymer waveguide 302.

The top conductor layer can be formed to include a metal layer, a superconductor layer, or a conductive polymer, for example. The top conductor can be plated to increase its thickness. The high-speed electrode 310 can be operatively coupled to receive an electrical signal from a quadrature driver (not shown). According to embodiments, the ground electrode 306 is disposed parallel to the high-speed electrode 310. An active region 312 of the optical polymer stack 308 including the trench polymer waveguide 302 can be positioned to receive a modulation signal from the high-speed electrode 310 and the ground electrode 306. The active region 312 can include an EO composition formed as a poled region that contains at least one second-order nonlinear optical (hyperpolarizable) chromophore, such as a chromophore 200 illustrated in FIG. 2.

In a TO tunable device 106, the active region 312 can be formed mainly to guide the light or mainly to guide the light and apply a refractive index change to modify phase (in a phase tuner) or to modify a reflected wavelength (in a Bragg grating or sample Bragg grating). In some embodiments, portions of the polymer optical stack (e.g., a bottom cladding layer 314 and/or a top cladding layer 316) can be more susceptible to change refractive index as a function of temperature than the active region 312. In such embodiments, the active region 312 can be regarded as mainly providing light guiding. In other embodiments (including embodiments described herein), the active region 312 can be at least as susceptible to change refractive index as a function of temperature than other portions 314, 316 of the optical polymer stack 308. In such embodiments, the active region 312 can be regarded as being formed both to guide the light and to apply the refractive index change to the guided light.

The optical polymer stack 308 can be configured to support the active region 312. The optical polymer stack 308 can include at least one bottom cladding layer 314 and at least one top cladding layer 316 disposed respectively below and above an electro-optic polymer layer 318. The bottom 314 and top 316 cladding layers, optionally in cooperation with a planarization layer (not shown), are configured to guide inserted light along a path in the plane of the electro-optic polymer layer 318. Trench polymer waveguides 302 are formed in the optical polymer stack 308 to guide the light along one or more light propagation paths through the electro-optic polymer layer 318. In the embodiment of FIG. 3, the trench polymer waveguide 302 is formed as a trench waveguide that includes an etched path in the at least one bottom cladding layer 314. Optionally, other waveguide structures may be used. For example a quasi-trench, rib, quasi-rib, side clad, etc. may be used singly or in combination to provide light guiding functionality. A ridge waveguide embodiment is shown in FIG. 4.

Continuing with FIG. 3, according to an embodiment, the TFPS can include a velocity-matching layer (not shown). The electro-optic polymer layer 318 can have a variable optical propagation velocity of light passed through it, which can, for example, be dependent on an electric field provided by the high-speed electrode 310 in cooperation with a ground electrode 306. The high-speed electrode 310 can be disposed over the top cladding layer 316 and under the velocity-matching layer (not shown), the high-speed electrode 310 having an electrical propagation velocity of electrical pulses passed through it. The velocity-matching layer can be configured to cause the electrical propagation velocity through the high-speed electrode 310 to approximate the optical propagation velocity through the electro-optic polymer layer 318. The top cladding layer 316 can be disposed over the electro-optic polymer layer 318 and below the velocity-matching layer, and can be configured to cause the coherent light to be guided along the E-O polymer layer 318. For typical waveguide applications, the top cladding layer 316 and bottom cladding layer 314 can be configured to convey a portion of light energy that is nominally passed through the electro-optic polymer layer 318. According to an alternative embodiment, the velocity-matching layer can be formed under the high-speed electrode 310 and over the top cladding layer 316.

According to another embodiment, an assembly substrate 126 can be selected to have a permittivity that provides the velocity-matching function of a separate velocity-matching layer.

To provide the velocity matching, the permittivity of the velocity-matching layer can be selected to cause the electrical propagation velocity through the high-speed electrode 310 to approximate the optical propagation velocity through the electro-optic polymer layer 318, and particularly through the trench polymer waveguide 302. According to an embodiment, the velocity-matching layer includes a polymer made from a monomer, an oligomer, or a monomer and oligomer mixture containing the monomer:

[chemical structure]

Polymerization of the velocity-matching layer can be radiation-initiated. For example, the velocity-matching layer can include a photoinitiator, a photosensitizer with an initiator, or a mixture of a photoinitiator and a photosensitizer with an initiator.

According to embodiments, the layers 314, 318, and 316 can each be formed by spin coating followed by drying, polymerization, and/or cross-linking on the substrate 304 and/or over previously spin-coated layers on the substrate 304. According to embodiments, the bottom cladding layer 314 can be formed to have a thickness of 2.4 to 2.8 micrometers. The trench polymer waveguide 302 can be etched into the bottom cladding layer 314 to a depth of 1.0 to 1.2 micrometers, leaving a 1.4 to 1.6 micrometer thickness of bottom cladding layer 314 under the trench waveguides 302. The trench polymer waveguide 302 can be etched to a width of 3.8 to 4.0 micrometers. The electro-optic polymer layer 318 can be formed to have a thickness of 2.15 to 2.2 micrometers over the bottom cladding layer 314 surface, thus having a thickness of 3.15 to 3.4 micrometers through the trench waveguide 302. The top cladding layer 316 can be formed to have a thickness of 1.4 to 1.6 micrometers. An optional velocity-matching layer can be formed to have a thickness of 6 to 8 micrometers, or can be formed integrally with the assembly substrate 320. The top electrode 310 width can be about 12 micrometers.

Typically the refractive indices of the one or more bottom cladding layers 314, E-O polymer layer 318, and one or more top cladding layers 316 are selected to guide the range of wavelengths of light along the core 312 that are to be output by the tunable laser 102. For example, the top and bottom cladding layers 316, 314 can be selected to have an index of refraction of about 1.35 to 1.60 and the E-O polymer layer 318 can be selected to have a nominal index of refraction of about 1.57 to 1.9. According to one illustrative embodiment, the top and bottom cladding layers 316, 314 each have an index of refraction of about 1.50 and the E-O polymer layer 318 has an index of refraction of about 1.74. According to embodiments, one or more bottom cladding, side cladding, and/or one or more top cladding layers can include materials such as polymers (e.g., crosslinkable acrylates or epoxies or electro-optic polymers with a lower refractive index than electro-optic polymer layer), inorganic-organic hybrids (e.g., “sol-gels”), and inorganic materials (e.g., SiOx).

The top cladding layer 316 (or optional velocity matching layer) may be adhered to an assembly substrate 126 using an optical adhesive 320, for example. Optionally, the high-speed electrode 310 may be formed on the assembly substrate 126. For example, a patterned (e.g., via hard mask) region of titanium dioxide and/or vacuum deposited gold, aluminum, or silver can act as a seed layer for receiving electroplating in a solution reaction.

Illustrative chromophore structures B71 and B74 (including bulky group substitutions) synthesized by the applicant are shown below. The B71 and B74 chromophores show good compatibility with host polymers and lead to high glass transition temperatures and high (Telcordia) stability.

[chemical structure]

Approaches for synthesizing the B71 and B74 chromophores depicted above are disclosed in U.S. patent application Ser. No. 12/959,898, entitled Stabilized Electro-Optic Materials and Electro-Optic Devices Made Therefrom, filed Dec. 3, 2010; and in U.S. patent application Ser. No. 12/963,479, entitled Integrated Circuit with Optical Data Communication, filed Dec. 8, 2010 which are, to the extent not inconsistent with the disclosure herein, incorporated by reference in their entirety, and for purposes beyond showing approaches for synthesis.

A poling process was performed at a temperature range from 164° C. to 220° C. with a positive and/or negative bias voltage ranging from 90 volts per micrometer (V/μM) to 200 V/μM to align the chromophores. The choice of poling temperature and voltage depends on the E-O polymer layer 318 materials.

Other properties that contribute to a successful integration of the optical polymer stack 308 with the substrate 304 include good adhesion to metal, oxide, and semiconductor portions of the substrate surface, sufficient elasticity to compress or stretch corresponding to thermal expansion of the substrate 304 and substrate portions, low optical loss, and high electro-optic activity. Such considerations can be satisfied by material systems described herein.

After poling, an electrical modulation field can be imposed through the volume of chromophores. For example, if a relatively negative potential is applied at the negative end and a relatively positive potential applied at the positive end of the poled chromophores, the chromophores will at least partially become non-polar. If a relatively positive potential is applied at the negative end and a relatively negative potential is applied at the positive end, then the chromophores will temporarily hyperpolarize in response to the applied modulation field. Generally, organic chromophores respond very quickly to electrical pulses that form the electrical modulation field and also return quickly to their former polarity when a pulse is removed.

A region of poled second order non-linear optical chromophores generally possesses a variable index of refraction to light. The refractive index is a function of the degree of polarization of the molecules. Thus, light that passes through an active region will propagate with one velocity in a first modulation state and another velocity in a second modulation state.

Referring to FIG. 1 in conjunction with FIG. 3, according to an embodiment, a driver circuit 128 can be configured to drive the electrodes 306, 310 with a series of modulated electrical pulses. A resultant modulated electrical field is thus imposed across the active region 312, and results in modulated hyperpolarization of the poled chromophores embedded therein. A complex of electrodes 306, 310 and the active region and light guidance structure 302 can be designated as an optical device. The modulated hyperpolarization can thus modulate the velocity of light passed through the poled trench polymer waveguide 302 of the optical polymer stack 308. Repeatedly modulating the velocity of the transmitted light creates a phase-modulated light signal emerging from the active region. The active region 312 can be combined with light splitters, combiners, and other active regions to create light amplitude modulators, such as in the form of a Mach-Zehnder EO optical modulator. In embodiments where the bottom electrode 306 (or optionally, a top electrode 310) is formed as an electrical resistor, the structure 300 can form a TO device 106 such as a TO phase tuner 108 and/or a TO Bragg grating 110 that responds to voltage and current applied by a TO control circuit 128. The polymer waveguide splitter 112 can be formed from the same optical stack structure 308. In such an embodiment, the TO optical device 106, the polymer waveguide splitter 112, and the EO modulator 114 can be considered to be formed as waveguides continuous with one another.

In some embodiments, the optical combiner 116 is formed separately from the devices on the substrate 303. In such an embodiment, light can be launched from waveguides 302 forming the EO modulator 114 to waveguides forming the optical combiner 116. In other embodiments, the optical combiner 116 can be formed continuous with the waveguides of the TO optical device 106, the polymer waveguide splitter 112, and the EO modulator on a single substrate 304.

FIG. 4 is a cross-section of an optical structure 400 including an illustrative rib polymer waveguide 402 that can be used in the TOSA of FIG. 1, according to an embodiment. The structure 400 may be regarded as an alternative to the structure 300 shown in FIG. 3. Optionally, a portion of the TO optical device 106, polymer waveguide splitter 112, EO modulator 114, and optical combiner 116 can be formed as trench waveguide structures 300, and another portion can be formed as rib waveguide structures 402. Optical tapers may optionally be used to transition from one optical structure to another optical structure 300, 400.

A rib waveguide 402 may be formed from a polymer core material. A top optical cladding 316 may be formed above the polymer core material such as an optical polymer material layer 318 including a hyperpolarizable chromophore of FIG. 2, according to an embodiment. The optical polymer layer 318 may be formed over a bottom cladding layer 314. The structure 400 can be formed from materials and using techniques described above in conjunction with FIG. 3.

Referring to FIG. 1, the TO tunable device 106 includes a phase tuner 108 configured to thermo-optically modify an optical path length of the tunable laser 102 and a Bragg grating 110 configured to select a reflected wavelength, and thereby a gain wavelength of the tunable laser 102, according to an embodiment.

FIG. 5A is a diagram of a distributed feedback (DFB) wavelength tunable laser including a TO tunable device with TO tuning heater electrodes, according to an embodiment. The TO tunable device can include a single Bragg grating configured to select the gain (reflected) wavelength responsive to a temperature set by a wavelength tuning electrode. A phase tuner can be configured to select the optical path length of the tunable laser responsive to a phase tuning electrode. The phase tuner is operated to select an optical path length equal or approximately equal to an integer multiple of the wavelength selected by the Bragg grating. This approach was found to substantially prevent mode-hopping.

FIG. 5B is a diagram of a DFB wavelength tunable laser embodiment including a TO tunable device 500 with TO tuning heater electrodes, according to another embodiment. The TO tunable device can include a beam splitter such as one or more Y-junctions and/or evanescent couplers configured to transmit light from the gain chip to two or more Bragg gratings 110a, 110b. The two or more Bragg gratings 110a, 110b are configured to select the gain wavelength of the tunable laser with respective wavelength tuning TO heater electrodes. A Y-junction between the phase tuner and the two or more Bragg gratings 110a, 110b can cooperate to select respective wavelength ranges for output by the DFB wavelength tunable laser.

FIG. 6A is a diagram of a wavelength selector formed from a uniform Bragg grating, according to an embodiment. FIG. 6B is a diagram of a wavelength selector formed from a sampled Bragg grating, according to an embodiment. Referring to FIGS. 6A and 6B, the Bragg grating is characterized by a period P configured to select the lasing wavelength of a DFB laser 102. W1 and W2 are waveguide widths in the Bragg grating. Energy from a guided beam carried by the Bragg grating is carried partially in cladding lateral to the waveguide core having the width W1. The extended structures corresponding to the width W2 partially reflect the incoming light. Additive partial reflectance causes reflection (and therefore gain) of light at a wavelength equal to twice the waveguide period P. TO modulation changes the optical period relative to the physical period P, which changes the reflected wavelength. Sampled Bragg gratings (shown in FIG. 6B) are characterized by two periods, Pg and Ps. Operation is similar to the constant period Bragg grating of FIG. 6A, but the sampling causes reflected wavelength to be adjustable over a wider spectrum. According to an embodiment, wavelengths that are a common half-multiple of optical path lengths corresponding to the two sampling periods Pg and Ps may be reflected. The optical path lengths can be selected for reflection by TO adjustment of the sampled Bragg grating. Interference between the resultant optical sampling periods can tune to a fundamental (and/or harmonic) selected reflection wavelength.

Referring to FIG. 1, the common substrate 126 can support a polymer waveguide splitter 112. The polymer waveguide splitter 112 can be aligned to receive the coherent light from the TO tunable device, to split the light into four modulation channels, and to output the four modulation channels into four push-pull Mach-Zehnder EO polymer modulator devices forming the EO modulator 114. Each of the four push-pull Mach-Zehnder EO polymer modulator devices can, in turn, include a splitter configured to split the coherent light into a push-pull waveguide pair. Practically speaking, the polymer waveguide splitter can be configured to split light from a single coherent light input channel into eight modulation channels, and to output the eight modulation channels into two push-pull waveguide pairs of each of four Mach-Zehnder EO polymer modulator devices forming the EO modulator 114.

An optical combiner 116 is configured to combine coherent light from two first push-pull Mach-Zehnder EO modulator pairs into a first polarization coherent quadrature modulated light signal and combine coherent light from two second push-pull Mach-Zehnder modulator pairs into a second polarization coherent quadrature modulated light signal. A polarization rotator is aligned to rotate polarization of the light from the second push-pull Mach-Zehnder modulator pairs. The optical combiner is also aligned to combine the first polarization coherent quadrature modulated light signal with the second polarization coherent quadrature modulated light signal to produce a dual polarization-quadrature modulated (DP-QM) light signal. The Mach-Zehnder EO modulators can be configured to modulate received coherent light according to a phase shift keyed (PSK) modulation schema. In such a case, the combined light signal is referred to as a dual polarization quadrature phase shift key modulated (DP-QPSK) signal.

A first optical coupling 120 is configured to launch light from the optical gain chip 104 into the TO tunable device 106 and launch reflected light from the TO tunable device back into the optical gain chip to form a distributed feedback (DFB) tunable wavelength laser.

A directional coupler (not shown) can be configured to substantially prevent light from passing from the EO modulator 114 to the TO tunable device 106 and the optical gain chip 104. A second optical coupling 122 can be configured to launch combined light from the EO modulator 114 into an optical fiber 124. A single package including an alignment or assembly substrate 126 can include the tunable laser 102 and the EO modulator 114.

A control circuit 128 can be configured to control or deliver power to the optical gain chip 104, can control or deliver power to the TO tunable device 106, and can modulate the EO modulator 114. The control circuit 128 can be configured to control or deliver power to each of a plurality of TO phase adjustors (not shown) associated with Mach-Zehnder push-pull modulator pairs of the EO modulator 114.

The control circuit 128 can be configured to control or deliver power to each of a plurality of quadrature phase adjustors (not shown) associated with Mach-Zehnder quadrature modulators of the EO modulator. Additionally or alternatively, the control circuit 128 can be configured to control or deliver power to a polarization phase adjustor (not shown) associated with one of two polarization channels before the polarization channels are combined by an optical combiner 116.

According to an embodiment, the optical sub-assembly 100 can include a transmitter optical sub-assembly (TOSA) configured to output the modulated light on a selectable one of a plurality of C band wavelengths. The plurality of C band wavelengths can include substantially all C band wavelengths.

C band refers to optical communication transmissions through a range corresponding to wavelengths over which an erbium-doped fiber amplifier (EDFA) can amplify the signal. According to embodiments, the optical sub-assembly 100 can support (i.e., transmit and/or receive modulated light signals across) a wavelength range of 1528 to 1566 nanometers. According to embodiments, each optical communication channel is separated from neighboring wavelengths by 25 GHz. DP-QPSK modulation is described in an earlier application by the inventors, U.S. patent application Ser. No. 13/674,058, entitled, “DUAL POLARIZATION QUADRATURE MODULATOR,” filed on Nov. 11, 2012, which, to the extent not inconsistent with this application, is incorporated by reference herein. The EO modulator 114 can be configured to modulate the coherent light as quadrature phase shift keyed (QPSK) modulated data.

The optical gain chip 104 and the TO tunable device 106 together form an external cavity laser. The TO tunable device can include a TO tunable Bragg grating configured to tune a wavelength and a TO phase modulator configured to control a modal aspect, a wavelength, or the modal aspect and the wavelength of the coherent light, and can output controlled C band coherent light.

According to an embodiment, an alignment substrate 126 can be configured to maintain optical alignment between at least the TO tunable device 106 and the optical gain chip 104. The substrate 304 can include a semiconductor, an insulator, or a semiconductor-on-insulator (SOI) substrate. The alignment substrate 126 can form a portion of a component package.

According to an embodiment, a third optical coupler (not shown) can be aligned to receive coherent light from the TO tunable device 106. A silicon optical amplifier (SOA) can be aligned to receive the coherent light from the first optical coupler and can be configured to amplify the transmitted optical power of the coherent light.

A fourth optical coupler (not shown) can be aligned to receive the amplified coherent light from the SOA and may be configured to launch the amplified coherent light to a polymer waveguide splitter 112 formed on the same substrate as the TO tunable device. The polymer waveguide splitter 112 can be configured to deliver split portions of the amplified coherent light to the EO modulator 114. The third and fourth optical couplers can include vertical launch devices configured to receive light from and deliver light to the polymer waveguide devices. The SOA (not shown) can be disposed in a plane defined by the polymer waveguide devices.

According to an embodiment, a DFB laser modulator includes an optical gain chip 104. A polymer phase tuner and a polymer Bragg grating continuous with the polymer phase tuner are aligned to receive radiation from the optical gain chip. A Mach-Zehnder polymer modulator is continuous with the polymer Bragg grating and the polymer phase tuner. The EO modulator may alternatively include a plurality of micro-ring resonators. The Bragg grating may include a polymer waveguide sampled Bragg grating.

The continuous a polymer phase tuner, polymer Bragg grating, and Mach-Zehnder polymer modulator can be formed, at least in part, from a single spun substrate. Additionally or alternatively, the continuous polymer phase tuner, polymer Bragg grating, and Mach-Zehnder polymer modulator can be formed at least partly by a hyperpolarizable chromophore waveguide core and at least one polymer clad layer.

According to an embodiment, the phase tuner and Bragg grating include thermo-optic (TO) devices. The hyperpolarizable chromophore waveguide core can be poled only in the Mach-Zehnder polymer modulator. Additionally or alternatively, the hyperpolarizable chromophore waveguide core TO devices can be formed of at least one poled portion of the waveguide core.

The waveguide core and the at least one polymer clad layer may be formed as a 3 micron partial ridge etched waveguide. The waveguide core and the at least one polymer clad layer can be configured to transmit greater than 50 milliwatt optical power, while meeting Telcordia standards.

According to an embodiment, the waveguide core and the at least one polymer clad layer can be configured to form a single mode beam residing at least one full width half max (FWHM) above the polymer waveguide core in an inner top clad layer. Additionally or alternatively, the at least one polymer clad layer can include the inner top clad layer and an outer top clad layer. The inner top clad layer can have a larger refractive index than the outer top clad layer.

FIG. 7 is a diagram of a DFB laser including a polymer ring resonator phase tuner, according to an embodiment. The DFB laser may include an optical gain chip such as an indum phosphide (InP) device. A polymer ring-resonator phase tuner can be aligned to receive radiation from the optical gain chip.

A silicon optical amplifier (SOA) may be aligned to receive radiation from the DFB gain chip. The polymer ring resonator phase tuner may be formed on a substrate separate from the SOA. Waveguide structures of the polymer ring resonator phase tuner and the SOA may be aligned via one or more bulk optic devices. A polymer beam splitter may aligned to the SOA via a bulk optical device. Continuous with the polymer beam splitter, a polymer electro-optic Mach-Zehnder modulator may be configured to modulate dual-polarization quadrature phase shift key modulated optical signals.

### Examples

FIGS. 5A and 5B are wavelength tunable integrated optical subassemblies based on polymer technology, according to an embodiment. There were two approaches to realize 100G TOSA in this invention. They were: 1) monolithically integrated TOSA. 2) hybrid monolithically integrated TOSA.

1) 100G Monolithically Integrated TOSA

With this approach 1, a tunable laser was integrated with a 100G DP-QPSK EO modulator via a Y-junction, as show in FIG. 5A. The tunable laser provided continuous wave (CW) light source with tuning range over the C-band (1528-1565 nm) for the LX8240 EO modulator.

The tunable laser consisted of a gain chip with InP substrate, phase tuning polymer waveguide and tunable polymer Bragg grating as shown in FIG. 5B.

The Bragg grating selected the lasing wavelength, and the electrodes over the polymer waveguide and the Bragg grating tuned the lasing wavelength. Meanwhile, the phase tuning waveguide acted to avoid the mode hopping when the laser was driving to provide high output optical power.

Two kinds of Bragg grating structures were used in the tunable laser to realize wide tenability. They were uniform Bragg grating (or regular Bragg grating) and Sampled Bragg Grating. The Bragg grating can be formed by having dimensional variation (teeth) in the horizontal direction, or vertical direction, or having refractive index variation. In FIG. 6A/6B, Bragg gratings have teeth in the horizontal direction as example.

In FIG. 6A, P is Bragg grating period which selected the lasing wavelength. W1 and W2 are waveguide widths in the Bragg grating, which determined the index modulation. Polymer Bragg grating and TM tunable lasers have been experimentally demonstrated with results shown as below. The TM tunable laser consisted of gain chip with InP substrate and polymer Bragg grating that is shown in FIG. 6A.

In FIG. 6B, Pg is a Bragg grating period that selects the lasing wavelength. Ps is the sampling period that determines the spectrum supermodes. W1 and W2 are waveguide widths in the Bragg grating, which determines the index modulation.

2) 100G Hybrid Monolithically Integrated TOSA

With this approach 2, a tunable laser was integrated with a 100G EO DP-QPSK modulator via lenses and SOA (Semiconductor Optical Amplifier) to provide high optical output power. FIG. 7 shows the schematic.

FIG. 8 shows polymer Bragg grating filtered effect reference to polymer waveguide without grating. 2.5 dB extra loss was attained, which corresponded to 43.8% optical power reflection. FIG. 9 shows the lasing spectrum of TM laser that included a gain chip and polymer waveguide Bragg grating. More than 40 dB SMSR has been obtained.

FIG. 10 shows the tuning results of the TM laser. A wavelength tuning range of about 13 nm was obtained.

FIG. 11 is a depiction of an integrated TOSA 1100, according to another embodiment. According to embodiments, the integrated TOSA 1100 includes an assembly substrate 1102 configured to maintain optical alignment between sections of the TOSA and between discrete components in some sections. A tunable laser section 102 operates according to approaches described above. The tunable laser 102 of the embodiment 1100 includes two optical gain chips, each configured to output approximately half the wavelength tuning range, such that the two optical gain chips and associated TO devices provide a full range of wavelength tenability (across the C band). Each optical gain chip is coupled to a corresponding TO device including a TO phase tuner and a TO Bragg grating. Waveguides output from the TO Bragg gratings are coupled (e.g., using a Y-junction) to provide a single waveguide output from the tunable laser section 102.

After CW coherent light is output from the tunable laser section 102, the light is launched to a wavelength locker section 1104. The laser output wavelengths (or frequencies) need to be accurately controlled. This is achieved by a multi-wavelength locker sub-module 1104. The multi-wavelength locker 1104 includes a beam splitter, etalon filter, and two photo detectors. The response of power from the etalon is periodic with frequency and has a free spectral range (FSR) of 50 GHz or other designated frequency spacing. According to some embodiments, the etalon output can optionally have a FSR of 25 GHz to provide closer channel-to-channel wavelength division multiplexed (WDM) spacing. A power-reference is used as a reference measurement of the average optical power. The ratio of photocurrent (Iₚ) from the etalon-coupled photodetector (PD) to the photocurrent Iₚ from the reference PD is used to lock the tunable laser to any of the available channels on the 50 GHz (or 25 GHz) spacing. Photocurrent feedback can be used by control circuitry (not shown) to adjust the amount of TO heating applied to the Bragg grating and the phase adjustor of the tunable laser 102.

A directional coupler can be placed in the main optical path to greatly reduce (>30 dB) risks of lasing instability due to optical back reflections from the EO modulator. A polarization rotator can be used to rotate the coherent laser light to vertical polarization for interaction with vertically-poled hyperpolarizable chromophores in the EO modulator. Optionally, the polarization rotator can form a portion of the directional coupler.

CW coherent light of the selected wavelength is launched from the wavelength locker 1104 to an input waveguide of a thin film polymer on silicon (TFPS) EO modulator section 1106. The TFPS modulator section 1106 can include an optical splitter 112 formed continuous with the EO modulators 114, as described above. According to an embodiment, the TFPS is capable of 100 GHz modulation on each channel. The channels can be maintained in synchronicity by a phase tuning TO device formed on one leg of each Mach-Zehnder modulator. The TFPS modulator 1106 can modulate each of four channels in phase shift-keyed (PSK) modulation schemes. One Mach-Zehnder modulator includes two arms arranged for push-pull modulation. Two Mach-Zehnder modulators can be operated in quadrature to one another, one modulator receiving a sine-derived signal and the other modulator receiving a cosine-derived signal. Data signals in quadrature can be resolved algorithmically by a receiver.

The TFPS section 1106 includes two such pairs of quadrature modulators. modulated light from each pair is launched from the TFPS modulator section 1106 to a polarization multiplexing (Pol-Mux) section 116, 1108 as two separate modulated light beams.

In order for a receiver to be able to resolve each quadrature pair, the polarization of light from one of the quadrature modulator pairs is rotated. Polarization maintaining fiber can be used to maintain the polarization states of the PSK data signals.

The input signal to the polymer DP-QPSK modulator is in TM (vertical) polarization. After the modulator section, the polarization of one of the QPSK channel is rotated 90 degrees. The QPSK signals are orthogonally polarized with a half-wave polarization rotator. The orthogonally polarized QPSK signals are then combined with beam combiner optics onto a single output waveguide as a dual polarization-quadrature phase shift keyed (DP-QPSK) signal. The selected wavelength can thus carry four independently modulated data channels. Monitoring photo diodes can be used to provide feedback to control electronics, for example for synchronizing the data signals from the four PSK modulating Mach-Zehnder modulators.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. An optical sub-assembly, comprising:
a tunable laser, further comprising:
an optical gain chip configured to output one or more of a plurality of modes of optical energy; and
a thermo-optic (TO) tunable device configured to tune wavelengths of the modes of optical energy, and to select one of the plurality of modes for lasing and output as coherent light on a tunable laser output waveguide; and
an electro-optic (EO) modulator operatively coupled to receive the coherent light from the tunable laser, to receive data, and to modulate the coherent light to output modulated light corresponding to the received data;
wherein the TO tunable device and the EO modulator are formed on a common substrate as polymer waveguide devices.

2. The optical sub-assembly of claim 1, wherein the tunable laser comprises a distributed feedback (DFB) semiconductor laser.

3. The optical sub-assembly of claim 1, wherein the optical gain chip comprises an indium phosphide semiconductor device.

4. The optical sub-assembly of claim 1, wherein the TO tunable device and the EO modulator are formed as polymer waveguide devices including a hyperpolarizable chromophore.

5. The optical sub-assembly of claim 4, wherein the hyperpolarizable chromophore includes at least one of: [chemical structure] [chemical structure]
wherein:
X is silicon or carbon;
R¹ is, independently at each occurrence, H, an alkyl group, a hetero alkyl group, an alkoxy group, an aryl group, or a hetero aryl group; and
R² is, independently at each occurrence, an alkyl group, a halogenated alkyl group, an aryl group, a substituted aryl group, or a halogenated aryl group.

6. The optical sub-assembly of claim 4, wherein the EO modulator includes hyperpolarizable chromophores that are vertically poled.

7. The optical sub-assembly of claim 4, wherein the TO tunable device includes hyperpolarizable chromophores that are vertically poled.

8. The optical sub-assembly of claim 4, wherein the TO tunable device includes non-poled hyperpolarizable chromophores.

9. The optical sub-assembly of claim 1, wherein the TO tunable device and the EO modulator are formed as polymer waveguide devices including a trench waveguide structure.

10. The optical sub-assembly of claim 1, wherein the TO tunable device and the EO modulator are formed as polymer waveguide devices including a ridge waveguide structure.

11. The optical sub-assembly of claim 1, wherein the TO tunable device further comprises:
a phase tuner configured to thermo-optically modify an optical path length of the tunable laser; and
a Bragg grating configured to select a gain wavelength of the tunable laser.

12. The optical sub-assembly of claim 11, wherein the TO tunable device further comprises:
a single Bragg grating configured to select the gain wavelength with a wavelength tuning electrode; and
a phase tuner configured to select the optical path length of the tunable laser with a phase tuning electrode.

13. The optical sub-assembly of claim 11, wherein the TO tunable device further comprises:
two or more Bragg gratings configured to select the gain wavelength of the tunable laser with respective wavelength tuning electrodes; and
a Y-junction between the phase tuner and the two or more Bragg gratings;
wherein the two or more Bragg gratings cooperate to select respective wavelength ranges for output by the DFB wavelength tunable laser.

14. The optical sub-assembly of claim 11, wherein the Bragg grating includes a uniform Bragg grating.

15. The optical sub-assembly of claim 11, wherein the Bragg grating includes a sampled Bragg grating.

16. The optical sub-assembly of claim 1, wherein the common substrate includes a polymer waveguide splitter aligned to receive the coherent light from the TO tunable device, to split the light into four modulation channels, and to output the four modulation channels into four push-pull Mach-Zehnder EO polymer modulator devices comprising the EO modulator.

17. The optical sub-assembly of claim 16, wherein each of the four push-pull Mach-Zehnder EO polymer modulator devices includes a splitter configured to split the coherent light into a push-pull waveguide pair.

18. The optical sub-assembly of claim 1, wherein the common substrate includes a polymer waveguide splitter aligned to receive the coherent light from the TO tunable device, to split the light into eight modulation channels, and to output the eight modulation channels into two push-pull waveguide pairs of each of four Mach-Zehnder EO polymer modulator devices comprising the EO modulator.

19. The optical sub-assembly of claim 1, further comprising:
an optical combiner configured to combine coherent light from two first push-pull Mach-Zehnder modulator pairs into a first polarization coherent quadrature modulated light signal, combine coherent light from two second push-pull Mach-Zehnder modulator pairs into a second polarization coherent quadrature modulated light signal, rotate polarization of the light from the second push-pull Mach-Zehnder modulator pairs, and combine the first polarization coherent quadrature modulated light signal with the second polarization coherent quadrature modulated light signal to produce a dual polarization-quadrature modulated (DP-QM) light signal.

20. The optical sub-assembly of claim 1, further comprising:
an optical combiner configured to combine coherent light from two first push-pull Mach-Zehnder phase shift key modulator pairs into a first polarization coherent quadrature phase shift keyed modulated light signal, combine coherent light from two second push-pull Mach-Zehnder phase shift key modulator pairs into a second polarization coherent quadrature phase shift keyed modulated light signal, rotate polarization of the light from the second push-pull Mach-Zehnder modulator pairs, and combine the first polarization coherent quadrature phase shift keyed modulated light signal with the second polarization coherent quadrature phase shift keyed modulated light signal to produce a dual polarization-quadrature phase shift keyed modulated (DP-QPSK) light signal.

21. The optical sub-assembly of claim 1, further comprising: a first optical coupling configured to launch light from the optical gain chip into the TO tunable device and to launch reflected light from the TO tunable device back into the optical gain chip to form a distributed feedback (DFB) tunable wavelength laser.

22. The optical sub-assembly of claim 1, further comprising: a directional coupler configured to substantially prevent light from passing from the EO modulator to the TO tunable device and the optical gain chip.

23. The optical sub-assembly of claim 1, further comprising:
a second optical coupling configured to launch combined light from the EO modulator into an optical fiber.

24. The optical sub-assembly of claim 1, further comprising:
a single package including the tunable laser and the EO modulator.

25. The optical sub-assembly of claim 1, further comprising:
a control circuit configured to control or deliver power to the optical gain chip, control or deliver power to the TO tunable device, and modulate the EO modulator.

26. The optical sub-assembly of claim 1, wherein the optical sub-assembly comprises:
a transmitter optical sub-assembly (TOSA) configured to configured to output the modulated light on a selectable one of a plurality of C band wavelengths.

27. The optical sub-assembly of claim 26, wherein the plurality of C band wavelengths includes substantially all C band wavelengths.

28. The optical sub-assembly of claim 1, wherein the EO modulator is configured to modulate the coherent light as quadrature phase shift keyed (QPSK) modulated data.

29. The optical sub-assembly of claim 1, further comprising:
continuous with the TO tunable device and the EO modulator, a plurality of light splitters configured to split the coherent light into a plurality of waveguides;

30. The optical sub-assembly of claim 1, wherein the optical gain chip and the TO tunable device together comprise an external cavity laser.

31. The optical sub-assembly of claim 1, wherein the TO tunable device further comprises:
a TO tunable Bragg Grating configured to tune a wavelength and a TO phase modulator operatively coupled to the tunable laser, and configured to control a modal aspect, a wavelength, or the modal aspect and the wavelength of the coherent light, and to output controlled C band coherent light.

32. The optical sub-assembly of claim 1, wherein the EO modulator is configured to apply dual polarization-quadrature phase shift keyed (DP-QPSK) modulation onto the controlled C band coherent light.

33. The optical sub-assembly of claim 1, further comprising an alignment substrate configured to maintain optical alignment between at least the TO tunable device and the optical gain chip.

34. The optical sub-assembly of claim 33, wherein the substrate is further configured to maintain optical alignment with the tunable laser.

35. The optical sub-assembly of claim 33, wherein the substrate includes a semiconductor or semiconductor-on-insulator (SOI) substrate.

36. The optical sub-assembly of claim 33, wherein the substrate forms a portion of the component package.

37. The optical sub-assembly of claim 1, further comprising:
a third optical coupler aligned to receive coherent light from the TO tunable device;
a silicon optical amplifier (SOA) aligned to receive the coherent light from the first optical coupler and configured to amplify the transmitted optical power of the coherent light; and
a fourth optical coupler aligned to receive the amplified coherent light from the SOA and configured to launch the amplified coherent light to a polymer waveguide splitter formed on the same substrate as the TO tunable device;
wherein the polymer waveguide splitter is configured to deliver split portions of the amplified coherent light to the EO modulator.

38. The optical sub-assembly of claim 37, wherein the third and fourth optical couplers include vertical launch devices configured to receive light from and deliver light to the polymer waveguide devices.

39. The optical sub-assembly of claim 37, wherein the SOA is disposed a plane defined by the polymer waveguide devices.

40. The optical sub-assembly of claim 1, wherein the EO modulator includes a plurality of micro-ring resonators.

41. The optical sub-assembly of claim 1, wherein the EO modulator includes a plurality of Mach-Zehnder modulators.

42. A DFB laser modulator, comprising:
an optical gain chip; and
aligned to receive radiation from the optical gain chip:
a polymer phase tuner;
a polymer Bragg grating continuous with the polymer phase tuner; and
a Mach-Zehnder polymer modulator continuous with the polymer Bragg grating and the polymer phase tuner.

43. The DFB laser modulator of claim 42, wherein the Bragg grating includes a polymer waveguide Sampled Bragg grating.

44. The DFB laser modulator of claim 42, wherein the continuous a polymer phase tuner, polymer Bragg grating, and Mach-Zehnder polymer modulator are formed, at least in part, from a single spun substrate.

45. The DFB laser modulator of claim 42, wherein the continuous polymer phase tuner, polymer Bragg grating, and Mach-Zehnder polymer modulator is formed at least partly by a hyperpolarizable chromophore waveguide core and at least one polymer clad layer.

46. The DFB laser modulator of claim 45, wherein the phase tuner and Bragg grating comprise thermo-optic (TO) devices.

47. The DFB laser modulator of claim 45, wherein the hyperpolarizable chromophore waveguide core is poled only in the Mach-Zehnder polymer modulator.

48. The DFB laser modulator of claim 45, wherein the hyperpolarizable chromophore waveguide core TO devices are formed of at least one poled portion of the waveguide core.

49. The DFB laser modulator of claim 45, wherein the waveguide core and the at least one polymer clad layer are etched or otherwise formed as a 3 micron partial ridge etch waveguide.

50. The DFB laser modulator of claim 45, wherein the waveguide core and the at least one polymer clad layer are configured to transmit greater than 50 milliwatt optical power, while meeting telecore standard.

51. The DFB laser modulator of claim 45, wherein the waveguide core and the at least one polymer clad layer are configured to form a single mode beam residing at least one full wave half max (FWHM) above the polymer waveguide core in an inner top clad layer; and
wherein the at least one polymer clad layer includes the inner top clad layer and an outer top clad layer; wherein the inner top clad layer has a larger refractive index than the outer top clad layer.

52. A DFB laser modulator, comprising:
a DFB gain chip;
aligned to receive radiation from the DFB gain chip, a polymer ring-resonator phase tuner; and
aligned to receive radiation from the DFB gain chip, a silicon optical amplifier (SOA);
wherein the polymer ring resonator phase tuner is formed on a substrate separate from the SOA.

53. The DFB laser modulator of claim 52, wherein waveguide structures of the polymer ring resonator phase tuner and the SOA are aligned via one or more bulk optic devices.

54. The DFB laser modulator of claim 52, further comprising, aligned to the SOA via a bulk optical device, a polymer beam splitter; and
continuous with the polymer beam splitter, a polymer electro-optic Mach-Zehnder modulator configured to modulate dual-polarization quadrature phase shift key modulated optical signals.
